(19) United States
(12) Patent Application Publication
(10) Pub. No.: US 2009/0240716 A1
(43) Pub. Date: Sep. 24, 2009

(54) DATA PROCESSING METHOD, SYSTEM, AND DEVICE FOR MULTIMEDIA DATA RECORDING AND DATA PATCHING METHOD THEREOF

(75) Inventors: Chi-Chun Lin, Tainan County (TW); Jaan-Huei Chen, Taipei City (TW); Te-Ming Chiu, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/051,999

(22) Filed: Mar. 20, 2008

(51) Int. Cl. G06F 17/30

(52) U.S. Cl. 707/101; 707/E17.009

(57) ABSTRACT

A data processing method is disclosed. A first stream data including a first part and a second part is received. The second part is processed according to the first part of the first stream data. The processed first stream data is transformed into a second stream data.

### BACKGROUND OF THE INVENTION

1. Field of the Invention

The invention relates to data processing, and more particularly to a data processing method, system, and device for multimedia data recording and a data patching method thereof.

2. Description of the Related Art

A packet of an I-picture may be lost due to data broadcasting with respect to a video sequence without a valid I picture. The problem can be improved by utilizing the I-picture of a previous access unit for a live video program or recorded sequential playback, but mosaic effects may occur.

In trick mode playback, an incomplete video sequence (without an I-picture, for example) that can not be presented may be skipped, advancing playback to the next video sequence with a valid I-picture. Thus, the trick mode playback may be not smooth. Additionally, the time required to locate the position of the incomplete recorded video sequence is unavailable.

Thus, the invention provides a data processing method, system, and device for multimedia data recording capable of patching a lost I-picture.

### BRIEF SUMMARY OF THE INVENTION

The invention provides data processing methods for recording broadcasted live data. An exemplary embodiment of a data processing method comprises the following. A first stream data comprising a first part and a second part is received from broadcasting. The second part is processed according to the first part of the first stream data. The processed first stream data is transformed into a second stream data.

Another embodiment of a data processing method for recorded data processing comprises the following. A first stream data comprising a first part and a second part and timing information is received from a storage medium. The second part is processed according to the first part of the first stream data and the timing information. The processed first stream data is transformed into a second stream data.

The invention further provides data processing devices. An exemplary embodiment of a data processing device comprises a demultiplexer, a processing unit, and a multiplexer. The demultiplexer receives a first stream data comprising a first part and a second part. The processing unit processes the second part according to the first part of the first stream data. The multiplexer multiplexes the processed first stream data to a second stream data.

The invention further provides data processing systems. An exemplary embodiment of a data processing system comprises a demultiplexer, a processing unit, and a multiplexer. The demultiplexer receives a first stream data comprising a first part and a second part. The processing unit processes the second part according to the first part of the first stream data. The multiplexer multiplexes the processed first stream data to a second stream data.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates an exemplary format of a transport stream (TS);

FIG. 2 illustrates an exemplary format of a packetized elementary stream (PES);

FIG. 3 illustrates MPEG-2 transport stream generation from layered video frames;

FIG. 4 illustrates an exemplary format of a a program stream (PS);

FIG. 5 illustrates the MPEG-2 video stream data hierarchy;

FIG. 6 is a schematic view of an embodiment of a data processing device for multimedia data recording;

FIGS. 7 and 8 illustrate video stream patch;

FIG. 9 is a flowchart of an embodiment of a data patching method for a video stream;

FIGS. 10A and 10B are flowcharts of another embodiment of a data patching method for a video stream; and

FIG. 11 is a flowchart of an embodiment of a data patching method for an audio stream.

### DETAILED DESCRIPTION OF THE INVENTION

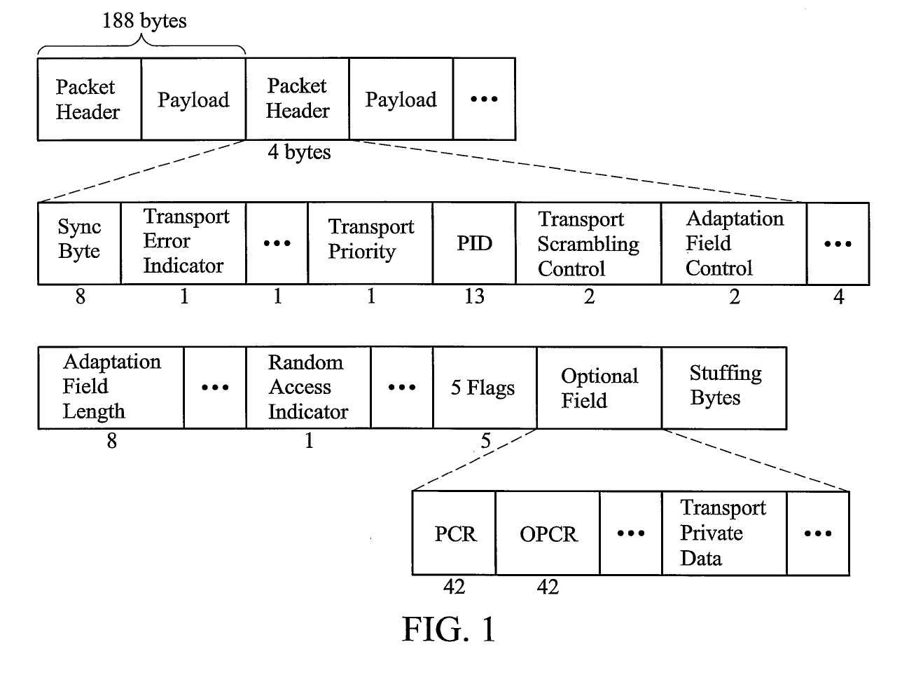

Several exemplary embodiments of the invention are described with reference to FIGS. 1 through 11, which generally relate to multimedia data recording. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a data processing method, system, and device for multimedia data recording and a data patching method thereof.

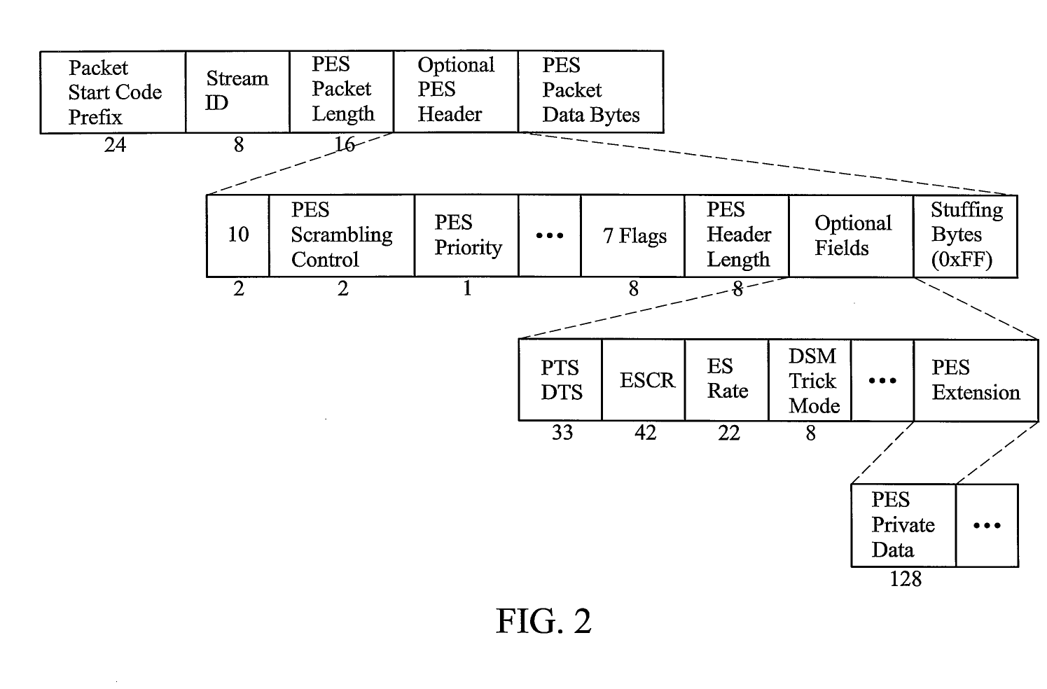

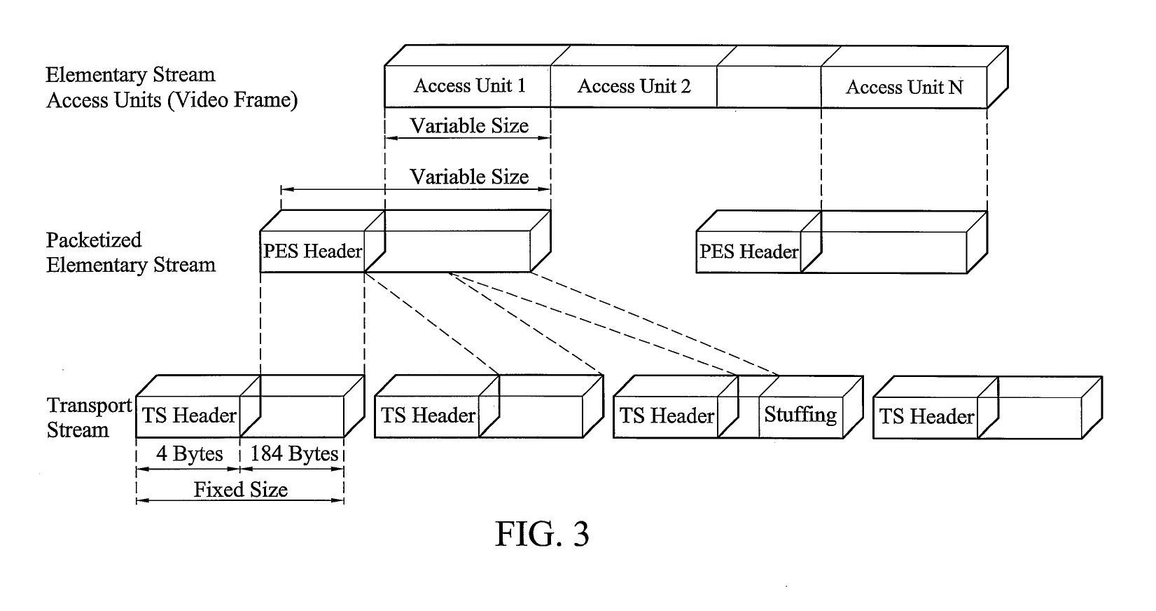

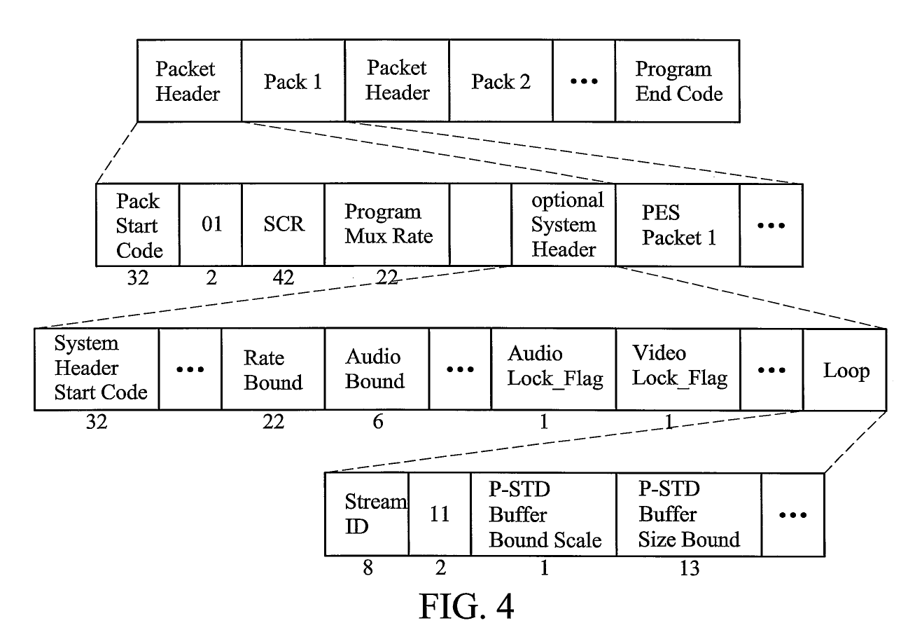

An embodiment of a data processing method, system, and device receives and demultiplexes a transport stream (TS) as shown in FIG. 1, to video and audio packetized elementary streams (PES), as shown in FIGS. 2 and 3. FIG. 3 illustrates the MPEG-2 transport stream generation from layered video frames. The video and audio packetized elementary streams are parsed to video and audio elementary streams (ES), as shown in FIG. 3. It is noted the sequence of the TS header and the PES header can be changed, which is not to be limitative. A video sequence is patched from the video and audio elementary streams when an I-picture is valid. And the video and audio elementary streams are multiplexed to a transport or a program stream (PS) as shown in FIG. 4.

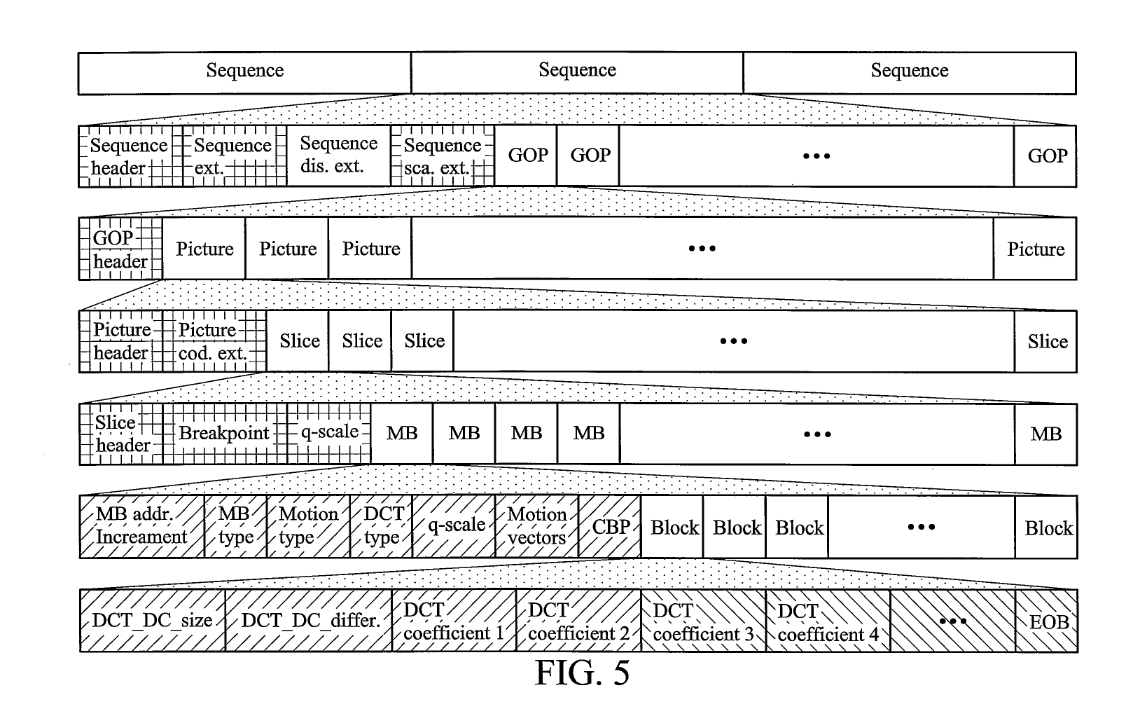

FIG. 5 illustrates the MPEG-2 video stream data hierarchy. The MPEG-2 video stream data hierarchy is composed of group of pictures (GOP), pictures, slice, macroblocks, and blocks. A video sequence begins with one or more sequence headers, including one or more groups of pictures, and ends with an end-of-sequence code. A GOP comprises a header and a series of one or more pictures allowing random access to the sequence. The picture represents the primary coding unit of a video sequence. One picture consists of three rectangular matrices representing one luminance (Y) and two chrominance (Cb and Cr) values. The Y matrix comprises an even number of rows and columns. A slice represents one or more “contiguous” macroblocks. Slices are important in the handling of errors. If a bitstream contains an error, a decoder can skip to the start of the next slice. Multiple slices in the bitstream allow better error concealment. A macroblock is the basic coding unit in the MPEG algorithm. A block is the smallest coding unit in the MPEG algorithm, and there are three types of blocks: luminance (Y), red chrominance (Cr), or blue chrominance (Cb).

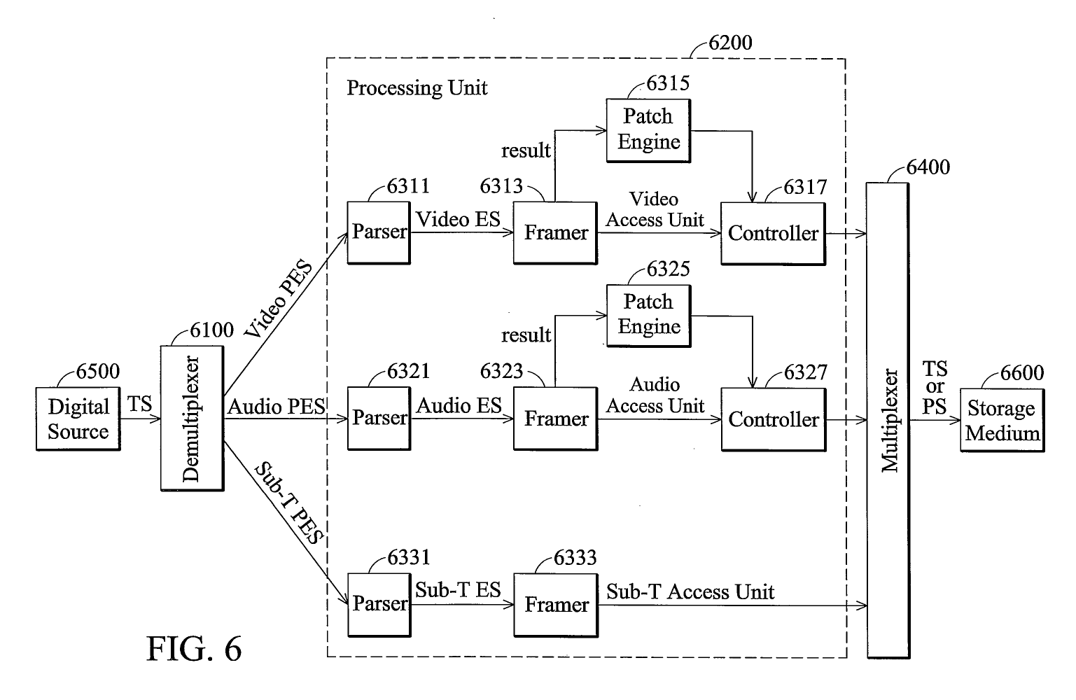

FIG. 6 is a schematic view of an embodiment of a data processing device for multimedia data recording.

An embodiment of a data processing device comprises a receiver 6100, such as a demultiplexer, a processing unit 6200, and a transformer 6400, such as a multiplexer. The processing unit 6200 further comprises a parser 6311 for video stream parsing, a framer 6313, a patch engine 6315, a controller 6317, a parser 6321 for audio stream parsing, a framer 6323, and a patch engine 6325, a controller 6327, a parser 6331 for subtitle stream parsing, and a framer 6333. When an I-picture of a received video sequence is invalid, a valid I-picture of the latest received video sequence is applicable for video coherence.

The demultiplexer 6100 receives, from a digital source 6500, and demultiplexes a multimedia data stream (a transport stream, for example) to video PES, audio PES, and other sub PES (sub transport PES, for example). Parsers 6311, 6321, and 6331 receive and parse the video, audio, and sub PES to video, audio, and sub elementary streams (ES), respectively. Next, the framer 6313 receives and processes the video ES and checks the completeness of an incoming access unit of the video ES. As defined in the specification ISO/IEC 13818-1, an access unit is a coded representation of a presentation unit. If the incoming access unit is valid, the framer 6313 sends a message to the controller 6317. If the incoming access unit is invalid, the incoming access unit is transmitted to the patch engine 6315. The patch engine 6315 inserts a valid access unit to the current incoming access unit and then sends another message to the controller 6317. The controller 6317 selectively receives the access unit from the framer 6313 or from the patch engine 6315 according to the received messages and transmits the access unit to the multiplexer 6400. The multiplexer 6400 receives the patched video access unit from the patch engine 6315 or an original video access unit from the framer 6313. Additionally, the digital source 6500 may be a device retrieving a transport stream from a storage device/medium or a tuner with a demodulator. The tuner is connected with an antenna while the demodulator transforms analog signals from the tuner into a digital transport stream and transmits the digital transport stream to a demultiplexer.

Next, the parser 6321, framer 6323, and patch engine 6325 process an incoming access unit of the audio ES and transmit the patched audio access unit or an original audio access unit to the multiplexer 6400. The parser 6331 and framer 6333 process an incoming access unit of the subtitle ES and transmit an access unit of the subtitle ES to the multiplexer 6400. Similarly, the controller 6327 selectively receives the audio access unit from the framer 6323 or from the patch engine 6325 according to the received messages and transmits the audio access unit to the multiplexer 6400. When processed video, audio, and subtitle ES have been received, the multiplexer 6400 multiplexes the ES to PES and merges the PES to PS or TS, and transmits and stores the PS or TS in the storage medium 6600.

The framer 6311 detects the packet unit start indicator (PUSI) for the transport stream level. With respect to the PES level, the framer 6311 detects a PES packet header, obtains the PES packet length, and obtains the presentation time stamp (PTS) and the decoding time stamp (DTS) time. With respect to the ES level, the framer 6311 detects the sequence header and end, detects a GOP header, detects an I-picture header or a P or B-picture header, and determines a playback time period for a video sequence.

The patch engine 6315 could patch the video sequence to become a valid video sequence according to the framer checking result. This includes the patching of sequence header, GOP header, I-picture, and sequence end.

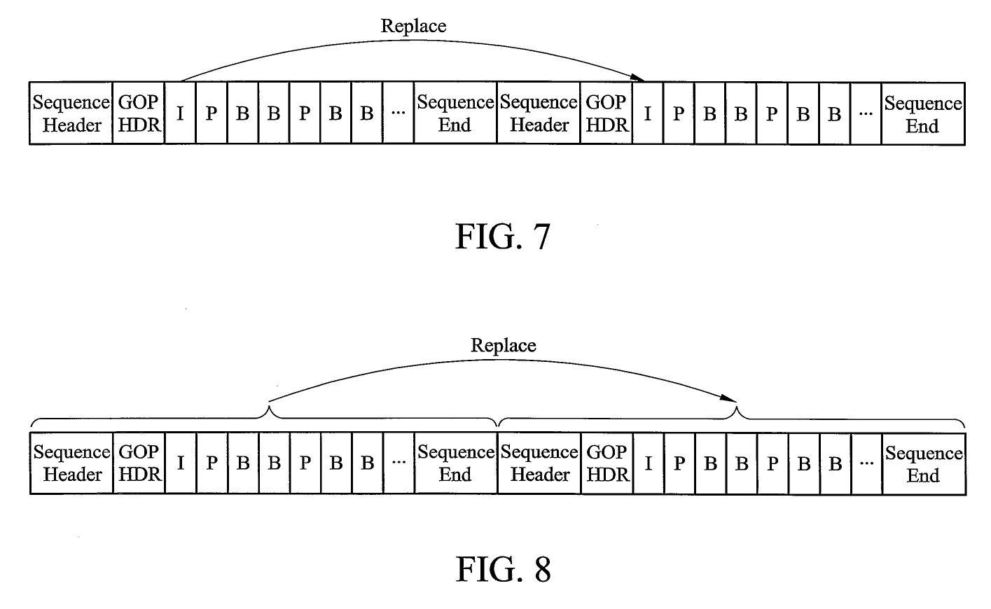

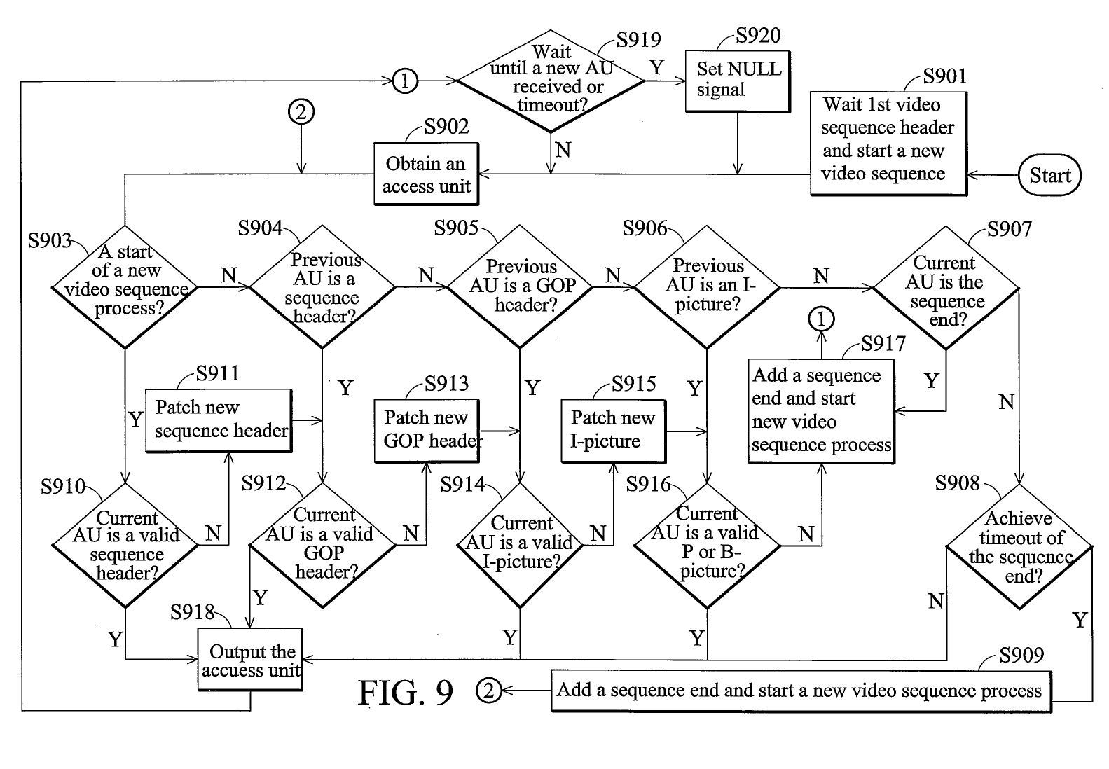

For I-picture patching, two methods are proposed. One is to patch I-picture only, as shown in FIG. 7. Another method is to patch whole GOP, including I-picture, B-pictures, and P-pictures, as shown in FIG. 8.

In this case, the patch engine needs to buffer previous valid I-picture or the whole GOP and use it for patching. Please note that the patch engine could also use a blank I-picture or GOP for this purpose.

In different conditions, the patch engine may use different methods to patch the stream. For example, if the received I-picture is invalid and the P and B pictures of the currently incoming video sequence have been received in time (<=500 ms, for example), it could patch the I-picture only, as shown in FIG. 7.

Another example is that there is no valid I, P, and B pictures, and then a sequence end or new sequence header, GOP header, or I-picture header is received in time, it could patch the whole GOP. If no new sequence header, GOP header, or I-picture header is received in time, it could also patch the whole GOP when timeout (>500 ms, for example).

If there are some invalid or missed B-picture or P-picture, while valid sequence header, GOP header, and I-picture are already there, the patch engine does not patch these invalid or missed B-picture or P-picture. The patch engine will patch the video sequence to have a valid sequence end directly. And the patch engine could determine the sequence end is missed when a new video sequence is detected or the sequence end is not received in time. The new video sequence detection could be implemented as when receiving a new video sequence header, GOP header, or I picture.

When it is required to patch a video sequence header, if the video attributes (comprising H/V picture sizes, frame rates, aspect ratios, and so forth) of the video sequence containing only one GOP are not uniform, the video sequence is replaced by another valid video sequence. Further, if the intra and non-intra quantizer matrix is detected in a video sequence, they are replaced by a previous video sequence's matrix or a default quantizer matrix. When a timeout of a sequence header or end or an I-picture occurs, the number of pictures for one video sequence are counted and a PTS of an I-picture for 0.5 seconds of a video sequence playback time is adjusted. The remaining pictures wait for another 0.5 seconds of a timeout. In this case, the invalid P or B-picture sequences are not checked. Note that if the modulator is used and the packet lost information can be provided, the patch mechanism should not be enabled.

Since the GOP header has a fixed format, when patching a GOP header is required, only determining the time code closed_gop flag and broken_link flag is needed. The time code could be determined by adding the previous time code to the previous GOP playback time. A drop frame flag is set to 0 and a marker bit is set to 1. Additionally, a closed_gop flag is set to 0 and a broken_link flag is set to 1 to skip the first two B-pictures.

When patching an I-picture header is required, an I-picture is coded as “2” for temporal reference and the VBV delay is decoded as “0xFFFF”. When patching a P/B-picture is required, a P or B-picture is skipped if missed or incorrect. Further, the video sequence playback time is not changed and the last decoded picture is displayed for more than one frame.

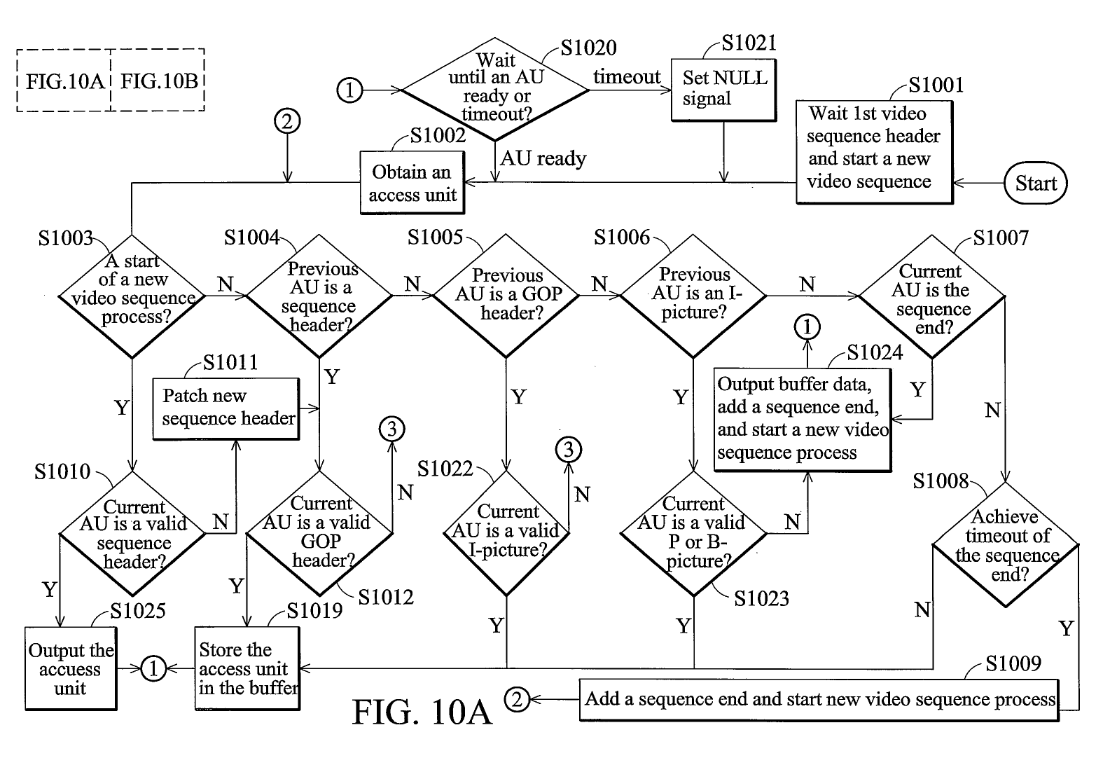

FIG. 9 is a flowchart of an embodiment of a data patching method for video stream.

When initiated, the recording process waits for the first video sequence header and starts a new video sequence (step S901), and obtain an access unit (step S902). Next, determine whether it is the start of a new video sequence process (step S903). If not, indicating a previously received video sequence is currently being processed, it is then determined whether a previous AU is a sequence header of the current video sequence (step S904). If the previous AU is not the sequence header of the current video sequence, it is then determined whether the pervious AU is a GOP header of the current video sequence (step S905). If the previous AU is not the GOP header of the current video sequence, it is then determined whether the previous AU is an I-picture of the current video sequence (step S906). If the previous AU is not the I-picture of the current video sequence, it is then determined whether the current AU is a sequence end of the current video sequence (step S907). If the current AU is not a sequence end of the current video sequence, it is then determined whether a timeout for the sequence end has occurred (step S908). If the timeout for the sequence end has occurred, a sequence end is added to the current video sequence and start a new video sequence (step S909). The process then proceeds to step S903.

If it is the start of a new video sequence, it is then determined whether a current AU is a valid sequence header of the new video sequence (step S910). If the current AU is not a valid sequence header of the new video sequence, the sequence header is patched (step S911). When patching the sequence header is complete or the previous AU is the sequence header of the current video sequence as shown in Step S904, it is then determined whether a current AU is a valid GOP header of the new video sequence (step S912). If the current AU is not the valid GOP header of the new video sequence, patching the GOP header is performed (step S913). When patching the GOP header is complete or the previous AU is the valid GOP header of the current video sequence as shown in Step S905, it is then determined whether the current AU is a valid I-picture of the new video sequence (step S914). If the current AU is not the I-picture of the new video sequence, patching the I-picture is performed (step S915). When patching the I-picture header is complete or the previous AU is the valid I-picture of the current video sequence as shown in step S906, it is then determined whether the current AU is a valid P or B-picture (step S916).

If the current AU is not the valid P or B-picture, a patching process is not performed that a sequence end is added to the new video sequence, and starts a new video sequence process (step S917). The process then proceeds to step S919. If a sequence header of the new video sequence is valid or detected (step S910), the obtained access unit of the video sequence is output (step S918). Next, wait until a new AU is ready or a timeout of the video sequence has been achieved (step S919). If a new AU is incoming, the process proceeds to step S902 to obtain another access unit of the video sequence process. If the timeout has been achieved, a NULL signal is sent to the system itself to run the patching process (step S920), and another access unit of the video sequence is received.

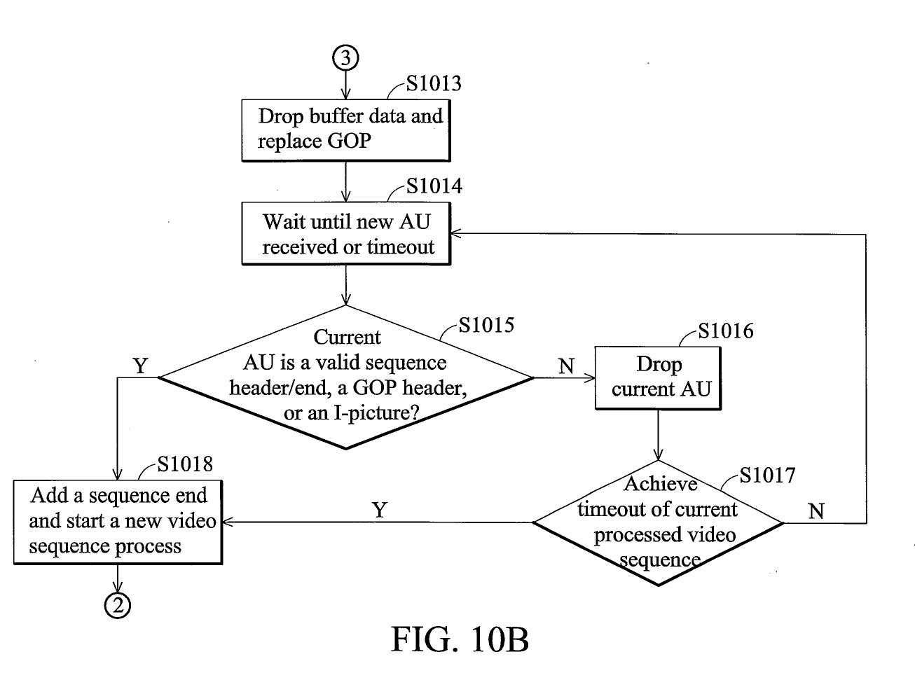

FIGS. 10A and 10B are flowcharts of another embodiment of a data patching method for a video stream.

When initiated, the recording process waits for the first video sequence header, starts a new video sequence process (step S1001), and obtains an access unit (step S1002). Next, it is determined whether it is the start of a new video sequence process (step S1003). If not, indicating a video sequence is currently being processed, it is then determined whether a previous AU is a sequence header of the current video sequence (step S1004). If the previous AU is not the sequence header of the current video sequence, it is then determined whether the pervious AU is a GOP header of the current video sequence (step S1005). If the previous AU is not the GOP header of the current video sequence, it is then determined whether the previous AU is an I-picture of the current video sequence (step S1006). If the previous AU is not the I-picture of the current video sequence, it is then determined whether the current AU is a sequence end of the current video sequence (step S1007). If the current AU is not a sequence end of the current video sequence, it is then determined whether a timeout for the sequence end has occurred (step S1008). If the timeout for the sequence end has occurred, the video data stored in a buffer is output, a sequence end is added to the current video sequence, and start a new video sequence (step S1009). The process then proceeds to step S1003.

If a new video sequence starts, it is then determined whether a current AU is a valid sequence header of the new video sequence (step S1010). If the current AU is not a valid sequence header of the new video sequence, the sequence header is patched (step S1011). When patching the sequence header is complete or the previous AU is a sequence header of the current video sequence as shown in Step S1004, it is then determined whether the current AU is a GOP header of the new video sequence (step S1012). If the current AU is not a GOP header of the new video sequence, the video data stored in the buffer is dropped and the GOP is replaced by another valid GOP (step S1013). Next, the process waits until a new AU is received or a timeout of the video data is achieved (step S1014), and it is determined whether the current AU is a sequence header or end, a GOP header, or an I-picture of the video data (step S1015). If the current AU is not a sequence header or end, a GOP header, or an I-picture of the video data, the current AU is dropped (step S1016) and it is determined whether a timeout of the current processed video sequence has occurred (step S1017). If the current AU is a sequence header or end, a GOP header, or an I-picture of the video data or a timeout of the video sequence has occurred, a sequence end is added to the new video sequence, and a new video sequence process starts (step S1018).

Next, if the current AU is a valid GOP header of the new video sequence, the access unit for the video sequence is stored in the buffer (step S1019). A new AU is waited or a timeout of the video sequence has been achieved (step S1020). If an AU is ready, the process proceeds to step S1002 to obtain another access unit of the video sequence process. If the timeout has been achieved, a NULL signal is sent to the system itself to run the patching process (step S1021). When the previous AU is a GOP header as shown in Step S1005, it is then determined whether a current AU is a valid I-picture of the new video sequence (step S1022), and, if so, the process proceeds to step S1019, and, if not, to step S1013. When the previous AU is a valid I-picture of the current video sequence as shown in Step S1006, it is then determined whether the current AU is a valid P or B-picture (step S1023), and, if so, the process proceeds to step S1019, if not, the current process AU is output, a sequence end is added to the current video sequence, and start a new video sequence (step S1024). If the current AU is a sequence header of the new video sequence, the AU is output (step S1025).

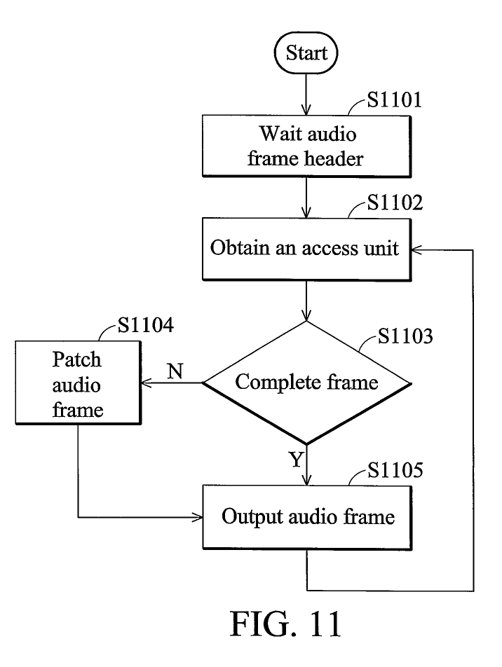

FIG. 11 is a flowchart of an embodiment of a data patching method for an audio stream.

The process waiting for a frame header of an audio frame is first performed (step S1101) and an access unit is obtained (step S1102). It is then determined whether the audio frame is a complete frame (step S1103). If the audio frame is not a complete frame, the audio frame is patched (step S1104). If the audio frame is a complete frame or the audio frame has been patched, the audio frame is output (step S1105).

With respect to patching an audio stream, an audio PES typically contains one patched audio frame. If the ABV buffer delay time has elapsed, the audio stream patching begins in which a previous audio frame repeats and an invalid frame is inserted. Additionally, the audio frame may be packed into one audio PES that the frame play time of which is added to the PTS for both valid and invalid frames.

The audio and video synchronization may be achieved during data patching. A framer assigns a PTS or DTS to each valid GOP and audio frame. Interpolation may be applied if one PES contains more than 1 GOP or 1 audio frame. Further, a patch engine may also assign a PTS or DTS for timeout patch. A framer cannot assign a value when a data stream is incomplete. Interpolation and extrapolation are employed according to the assigned PTS or DTS. Therefore, after patching this information, a multiplexer could multiplex a patched ES as a normal ES.

The TS is multiplexed to PS based on the system clock reference (SCR) and PTS or DTS. Buffer usage is counted based on a patched stream, while missed P or B-pictures are not counted. The SCR can be calculated using the following formulas:

SCR(i)=SCR_base(i)*300+SCR_{—}ext(i);

SCR_base(i)=((27 MHz*t(i))/300) % 2̂33; and

SCR_{—}ext(i)=(27 MHz*t(i)) % 300.

A “formal” frame number, according to a TV system format of a recording program, counts PTS or DTS even if parts of P or B-pictures are missed.

The TS is processed, demultiplexed, and multiplexed to PS based on the program clock reference (PCR) and arrival time stamps

The digital program (Transport Program) can first be stored in a storage medium (such as a Hard Disk Drive) and dubbed to an optical storage medium, for example, the digital versatile disc (DVD). The recorded TS packets may be assigned arrival time stamps. When dubbing a recorded program to the DVD, the timeout of a patch engine is counted based on the difference of arrival time stamps to support high speed dubbing if the DVD only supports the program stream.

The described data processing method, system, and device for multimedia data recording may provide better playback performance.

Methods and systems of the present disclosure, or certain aspects or portions of embodiments thereof, may take the form of program code (i.e., instructions) embodied in media, such as floppy diskettes, CD-ROMs, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data processing method, applied to process a first stream data comprising a first part and a second part, comprising:
receiving the first stream data;
processing the second part according to the first part of the first stream data; and
transforming the processed first stream data into a second stream data.

2. The data processing method as claimed in claim 1, wherein a wired or wireless stream data is further received in the receiving step.

3. The data processing method as claimed in claim 1, wherein the second part is further patched according to the first part of the first stream data in the processing step.

4. The data processing method as claimed in claim 1, wherein the second part is further processed according to the first part of the first stream data based on time or quality information in the processing step.

5. The data processing method as claimed in claim 1, wherein the first stream data is further demultiplexed to a third stream data in the processing step and the third stream data is transformed into the second stream data in the transforming step.

6. The data processing method as claimed in claim 1, wherein the second stream data is a program stream (PS) or a transport stream (TS).

7. The data processing method as claimed in claim 1, wherein the first stream data comprises audio and video data.

8. The data processing method as claimed in claim 1, wherein the second part is further processed based on audio and video synchronization in the processing step.

9. The data processing method as claimed in claim 1, wherein a GOP, a GOP header, a sequence header, a GOP end, a sequence end or an audio frame is further inserted in the processing step.

10. The data processing method as claimed in claim 9, wherein the audio frame comprises a flag representing an insertion state.

11. A data processing method, applied to process a first stream data comprising a first part and a second part, comprising:
receiving the first stream data and timing information from a storage medium;
processing the second part according to the first part of the first stream data and the timing information; and
transforming the processed first stream data into a second stream data.

12. A data processing device, applied to process a first stream data comprising a first part and a second part, comprising:
a receiver, receiving the first stream data;
a processing unit, processing the second part according to the first part of the first stream data; and
a transformer, multiplexing the processed first stream data to a second stream data.

13. The data processing device as claimed in claim 12, wherein the receiver further receives a wired or wireless stream data for data transformation.

14. The data processing device as claimed in claim 12, wherein the processing unit further comprises a patch engine for patching the second part according to the first part of the first stream data.

15. The data processing device as claimed in claim 14, wherein the patch engine further patches the second part according to the first part of the first stream data based on time or quality information.

16. The data processing device as claimed in claim 14, wherein:
the receiver demultiplexes the first stream data to a third stream data;
the processing unit further comprises a parser for parsing the third stream data to fourth stream data; and
the transformer transforms the fourth stream data into the second stream data.

17. The data processing device as claimed in claim 16, wherein the transformer multiplexes the fourth stream data to a program stream (PS) or a transport stream (TS).

18. The data processing device as claimed in claim 14, wherein the patch engine further inserts a GOP, a GOP header, a sequence header, a GOP end, a sequence end or an audio frame.

19. The data processing device as claimed in claim 18, wherein the audio frame comprises a flag representing an insertion state.

20. The data processing device as claimed in claim 12, wherein the first stream data comprises audio and video data.

21. The data processing device as claimed in claim 12, wherein the processing unit further processes the second part based on audio and video synchronization.

22. A computer-readable storage medium storing a computer program providing a data processing method, comprising using a computer to perform the steps of:
receiving a first stream data comprising a first part and a second part;
processing the second part according to the first part of the first stream data; and
transforming the processed first stream data into a second stream data.

23. A data processing system, applied to process a first stream data comprising a first part and a second part, comprising:
a receiver, receiving the first stream data;
a processing unit, processing the second part according to the first part of the first stream data; and
a transformer, transforming the processed first stream data into a second stream data.

24. A device, applied to process a first stream data comprising a first part and a second part, comprising:
means for receiving the first stream data;
means for processing the second part according to the first part of the first stream data; and
means for transforming the processed first stream data into a second stream data.
